(19) United States
(12) Patent Application Publication
(10) Pub. No.: US 2025/0119807 A1
(43) Pub. Date: Apr. 10, 2025

(54) INFORMATION OUTPUT DEVICE, INFORMATION OUTPUT METHOD, AND RECORDING MEDIUM

(71) Applicant: NEC Corporation, Minato-ku, Tokyo (JP)

(72) Inventors: Kohei Sugai, Tokyo (JP); Takashi Kuribara, Tokyo (JP); Masato Kita, Tokyo (JP); Ryosuke Kumagai, Tokyo (JP)

(73) Assignee: NEC Corporation, Minato-ku, Tokyo (JP)

(21) Appl. No.: 18/832,286

(22) PCT Filed: Mar. 11, 2022
(86) PCT No.: PCT/JP2022/011018

§ 371 Date: Jul. 23, 2024

(51) Int. Cl. H04W 36/20; H04W 24/08

(52) U.S. Cl. CPC H04W 36/20; H04W 24/08

(57) ABSTRACT

An information output device receives, for an in-use communication being a wireless communication used by wireless communication means for performing wireless communication, quality information being information about quality of the in-use communication from the wireless communication means, estimates occurrence of radio interference on the in-use communication, based on the quality information, acquires alternative communication information from storage means when occurrence of the radio interference on the in-use communication is estimated, and outputs output information including the alternative communication information. The storage means stores communication information being information about a wireless communication for each wireless communication available to the wireless communication means. The alternative communication information is the communication information of an alternative communication being a wireless communication available to the wireless communication means in place of the in-use communication.

### TECHNICAL FIELD

The present invention relates to an information output device and the like.

### BACKGROUND ART

One of factors in reduction of throughput in wireless communication is radio interference.

When throughput is reduced due to occurrence of radio interference, quality of a service provided by a wireless communication may be reduced. Examples of reduction in service quality include disruption in a reproduced video or voice, and degradation in control precision of remote control.

Therefore, when radio interference occurs, it is desirable to take action against the radio interference and eliminate the radio interference. However, factors in reduction in throughput may include a factor other than radio interference. Therefore, in order to take action against radio interference, investigation of whether radio interference is occurring is first required.

Reduction in throughput is generally detected by occurrence of reduction in service quality. Then, an investigation of whether radio interference is occurring is generally performed by an investigator going to a scene where reduction in service quality is occurring and the investigator investigating radio wave status and/or the like of the surroundings. Then, when radio interference is occurring, action against the radio interference is taken.

Related technologies include technologies described in PTL 1 and PTL 2.

### CITATION LIST

### Patent Literature

PTL 1: Japanese Unexamined Patent Application Publication No. 2011-015115
PTL 2: Japanese Unexamined Patent Application Publication No. 2012-054799

### SUMMARY OF INVENTION

### Technical Problem

However, a common method for investigating radio interference as described above is time-consuming since an investigator goes to a scene. Further, when radio interference occurs, it is difficult for a user to determine action to be taken for avoidance of an effect of the radio interference.

An object of the present invention is to, in view of the issues described above, provide an information output device and the like that enable output of information for action against radio interference to be more easily taken.

### Solution to Problem

An information output device according to an aspect of the present invention includes: a reception means for receiving, for an in-use communication being a wireless communication used by a wireless communication means for performing wireless communication, quality information being information about quality of the in-use communication from the wireless communication means; an estimation means for estimating occurrence of radio interference on the in-use communication, based on the quality information; an acquisition means for acquiring alternative communication information from a storage means when occurrence of the radio interference on the in-use communication is estimated; and an output means for outputting output information including the alternative communication information, wherein the storage means stores communication information being information about a wireless communication for each wireless communication available to the wireless communication means, the alternative communication information is the communication information of an alternative communication being a wireless communication available to the wireless communication means in place of the in-use communication, and the alternative communication is a wireless communication using a wireless communication method different from that used by the in-use communication or a wireless communication provided by an operator different from that of the in-use communication.

An information output method according to another aspect of the present invention includes: receiving, for an in-use communication being a wireless communication used by a wireless communication means for performing wireless communication, quality information being information about quality of the in-use communication from the wireless communication means; estimating occurrence of radio interference on the in-use communication, based on the quality information; acquiring alternative communication information from a storage means when occurrence of the radio interference on the in-use communication is estimated; and outputting output information including the alternative communication information, wherein the storage means stores communication information being information about a wireless communication for each wireless communication available to the wireless communication means, the alternative communication information is the communication information of an alternative communication being a wireless communication available to the wireless communication means in place of the in-use communication, and the alternative communication is a wireless communication using a wireless communication method different from that used by the in-use communication or a wireless communication provided by an operator different from that of the in-use communication.

An information output program according to another aspect of the present invention recorded on a computer-readable recording medium causes a computer to provide: a reception function of receiving, for an in-use communication being a wireless communication used by a wireless communication means for performing wireless communication, quality information being information about quality of the in-use communication from the wireless communication means; an estimation function of estimating occurrence of radio interference on the in-use communication, based on the quality information; an acquisition function of acquiring alternative communication information from a storage means when occurrence of the radio interference on the in-use communication is estimated; and an output function of outputting output information including the alternative communication information, wherein the storage means stores communication information being information about a wireless communication for each wireless communication available to the wireless communication means, the alternative communication information is the communication information of an alternative communication being a wireless communication available to the wireless communication means in place of the in-use communication, and the alternative communication is a wireless communication using a wireless communication method different from that used by the in-use communication or a wireless communication provided by an operator different from that of the in-use communication.

An information output system according to another aspect of the present invention includes: a reception means for receiving, for an in-use communication being a wireless communication used by a wireless communication means for performing wireless communication, quality information being information about quality of the in-use communication from the wireless communication means; an estimation means for estimating occurrence of radio interference on the in-use communication, based on the quality information; an acquisition means for acquiring alternative communication information from a storage means when occurrence of the radio interference on the in-use communication is estimated; and an output means for outputting output information including the alternative communication information, wherein the storage means stores communication information being information about a wireless communication for each wireless communication available to the wireless communication means, the alternative communication information is the communication information of an alternative communication being a wireless communication available to the wireless communication means in place of the in-use communication, and the alternative communication is a wireless communication using a wireless communication method different from that used by the in-use communication or a wireless communication provided by an operator different from that of the in-use communication.

### Advantageous Effects of Invention

The present invention enables output of information for action against radio interference to be more easily taken.

### BRIEF DESCRIPTION OF DRAWINGS

FIG. 1 is a diagram illustrating a configuration example of an information output device according to a first example embodiment of the present invention.

FIG. 2 is a diagram illustrating an example of an operation flow of the information output device according to the first example embodiment of the present invention.

FIG. 3 is a diagram illustrating a configuration example of a system including an information output device according to a second example embodiment of the present invention.

FIG. 4 is a diagram illustrating a configuration example of the information output device according to the second example embodiment of the present invention.

FIG. 5 is a diagram illustrating another configuration example of the information output device according to the second example embodiment of the present invention.

FIG. 6 is a diagram illustrating an example of an image which the information output device according to the second example embodiment of the present invention causes a display device to display.

FIG. 7 is a diagram illustrating an example of an image which the information output device according to the second example embodiment of the present invention causes the display device to display.

FIG. 8 is a diagram illustrating an example of an operation flow of the information output device according to the second example embodiment of the present invention.

FIG. 9 is a diagram illustrating a hardware configuration example according to each example embodiment of the present invention.

### EXAMPLE EMBODIMENT

### First Example Embodiment

A first example embodiment of the present invention is described.

A specific example of an information output device 10 according to the first example embodiment is an information output device 20 according to a second example embodiment to be described later.

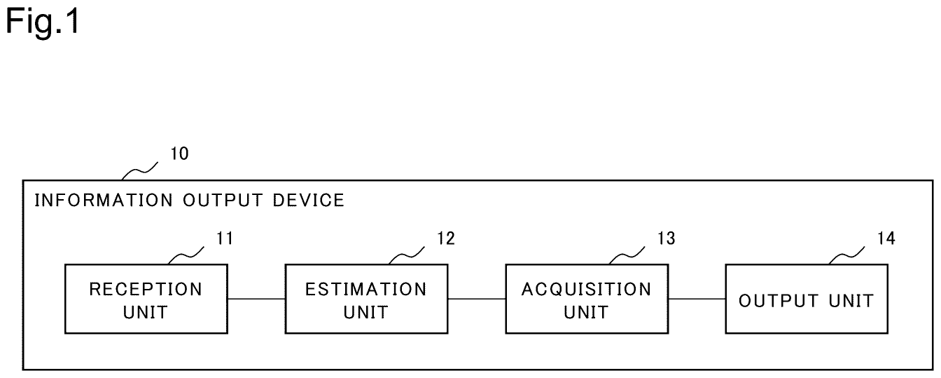

First, a configuration example the information output device 10 according to the present example embodiment is described. FIG. 1 illustrates a configuration example of the information output device 10 according to the present example embodiment. The information output device 10 includes a reception unit 11, an estimation unit 12, an acquisition unit 13, and an output unit 14.

The reception unit 11 (a reception means) receives quality information from a wireless communication means. The wireless communication means performs wireless communication. The quality information is information about the quality of an in-use communication. The in-use communication is a wireless communication used by the wireless communication means.

The estimation unit 12 (an estimation means) estimates occurrence of radio interference on an in-use communication, based on quality information.

The acquisition unit 13 (an acquisition means) acquires alternative communication information from a storage means when occurrence of radio interference on an in-use communication is estimated. The storage means stores communication information for each wireless communication available to the wireless communication means. Communication information is information about a wireless communication. An alternative communication is a wireless communication available to the wireless communication means in place of the in-use communication. Alternative communication information is communication information of an alternative communication.

A wireless communication available to the wireless communication means in place of the in-use communication is a wireless communication using a wireless communication method different from that used by the in-use communication or a wireless communication provided by an operator different from that of the in-use communication.

The output unit 14 (an output means) outputs output information including alternative communication information.

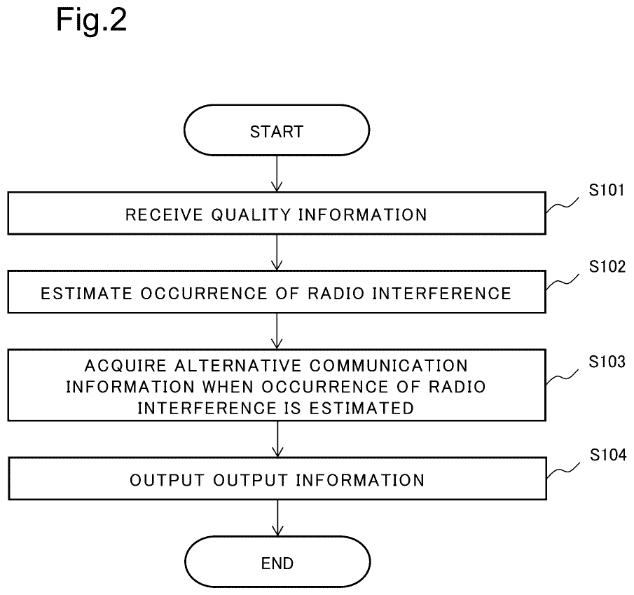

Next, an example of an operation flow of the information output device 10 according to the present example embodiment is described. FIG. 2 illustrates an example of the operation flow of the information output device 10 according to the present example embodiment.

The reception unit 11 receives quality information from the wireless communication means (Step S101). The estimation unit 12 estimates occurrence of radio interference on the in-use communication, based on the quality information (Step S102). The acquisition unit 13 acquires alternative communication information from the storage means when occurrence of radio interference on the in-use communication is estimated (Step S103). The output unit 14 outputs output information including the alternative communication information (Step S104).

As described above, the information output device 10 according to the first example embodiment of the present invention includes the reception unit 11, the estimation unit 12, the acquisition unit 13, and the output unit 14. The reception unit 11 receives quality information from a wireless communication means. The wireless communication means performs wireless communication. The quality information is information about the quality of an in-use communication. The in-use communication is a wireless communication used by the wireless communication means. The estimation unit 12 estimates occurrence of radio interference on the in-use communication, based on the quality information. The acquisition unit 13 acquires alternative communication information from the storage means when occurrence of radio interference on the in-use communication is estimated. The storage means stores communication information for each wireless communication available to the wireless communication means. Communication information is information about a wireless communication. An alternative communication is a wireless communication available to the wireless communication means in place of the in-use communication. Alternative communication information is communication information of an alternative communication. A wireless communication available to the wireless communication means in place of the in-use communication is a wireless communication using a wireless communication method different from that of the in-use communication or a wireless communication provided by an operator different from that of the in-use communication. The output unit 14 outputs output information including the alternative communication information.

Thus, the information output device 10 outputs information including communication information of a wireless communication available to a wireless communication means in place of an in-use communication when occurrence of radio interference on the in-use communication is estimated. Since information of a wireless communication available to the wireless communication means in place of the in-use communication is output from the information output device 10, a user can change a wireless communication used by the wireless communication means from the in-use communication to another wireless communication with reference to the output information. As a result, the possibility of radio interference being avoided and communication being continued increases. Further, the user can more easily take action against radio interference. Therefore, information for action against radio interference to be more easily taken can be output.

### Second Example Embodiment

Next, an information output device 20 according to a second example embodiment of the present invention is described. A specific example of the information output device 10 according to the first example embodiment is the information output device 20 according to the second example embodiment.

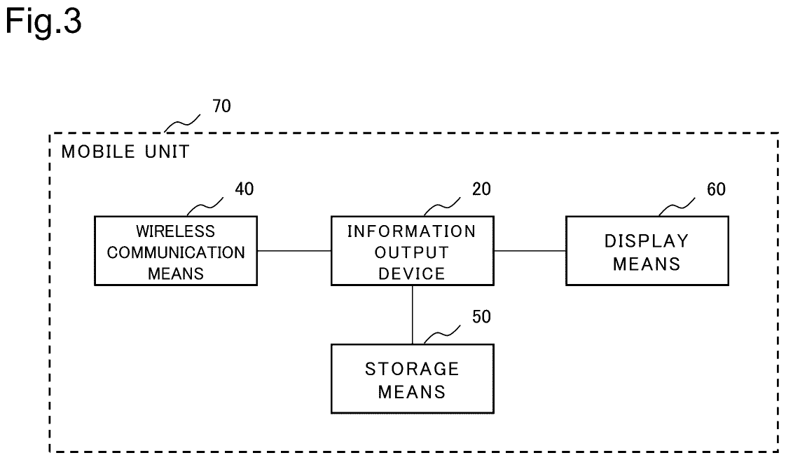

First, FIG. 3 illustrates a configuration example of a system including the information output device 20 according to the present example embodiment. The information output device 20 is mutually connected to a wireless communication means 40. Further, the information output device 20 is mutually connected to a display means 60. Further, the information output device 20 is mutually connected to a storage means 50. The storage means 50 and the wireless communication means 40 may be included in the information output device 20.

For example, the information output device 20, the storage means 50, the wireless communication means 40, and the display means 60 are included in a mobile unit 70. Examples of the mobile unit 70 include an aircraft, a ship, and a mobile phone.

The wireless communication means 40 performs wireless communication. The wireless communication means 40 can use a plurality of (two or more) wireless communications. The wireless communication means 40 can use a wireless communication based on any method. Examples of a wireless communication available to the wireless communication means 40 include mobile communication, wireless communication for business use, optical wireless communication (such as infrared communication and visible light communication), and short-distance wireless communication that are based on various methods. Wireless communications based on different wireless communication methods are handled as different wireless communications in the present example embodiment. Further, wireless communications using the same wireless communication method but providing services through different operators are handled as different wireless communications.

The wireless communication means 40 transmits quality information to the information output device 20. The quality information is information about the quality of an in-use communication. The in-use communication is a wireless communication used by the wireless communication means 40. Examples of the quality information include a received signal level, throughput, a packet error rate (PER), a bit error rate (BER), and a signal-to-interference-plus-noise ratio (SINR).

The storage means 50 stores communication information for each wireless communication available to the wireless communication means 40. Communication information is information about a wireless communication. Examples of information included in communication information include a name, an operating frequency band, and a communication method.

The display means 60 is a human-machine interface with an output device, such as a display. The display means 60 displays an image. It is assumed in the present example embodiment that the information output device 20 outputs output information to the display means 60. However, the output information may be output to any destination. The information output device 20 may output the output information to an output destination other than the display means 60.

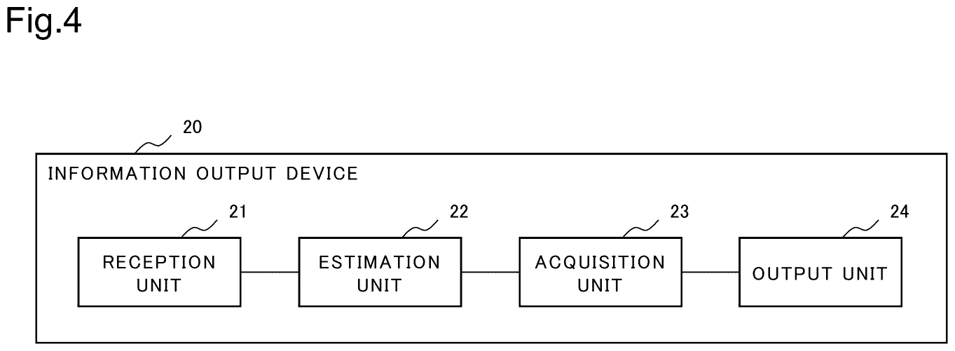

Next, FIG. 4 illustrates a configuration example of the information output device 20 according to the present example embodiment. The information output device 20 according to the present example embodiment includes a reception unit 21, an estimation unit 22, an acquisition unit 23, and an output unit 24.

The reception unit 21 receives quality information of an in-use communication from the wireless communication means 40. The in-use communication is a wireless communication used by the wireless communication means 40. The quality information is information about the quality of the in-use communication.

The estimation unit 22 estimates occurrence of radio interference on the in-use communication, based on the quality information.

The estimation unit 22 performs estimation, based on an estimation condition. The estimation condition is a condition satisfied when radio interference is occurring. The estimation condition includes a condition related to the quality information received from the wireless communication means 40. The estimation unit 22 estimates that radio interference is occurring when the estimation condition is satisfied. The estimation unit 22 estimates that radio interference is not occurring when the estimation condition is not satisfied. A method for estimating radio interference is described later.

The acquisition unit 23 acquires alternative communication information from the storage means 50 when occurrence of radio interference on the in-use communication is estimated. Alternative communication information is information about an alternative communication. An alternative communication is a wireless communication available to the wireless communication means 40 in place of the in-use communication. Alternative communication information is communication information of an alternative communication. A method for acquiring alternative communication information is described later.

The output unit 24 outputs output information including alternative communication information. The output unit 24 according to the present example embodiment outputs the output information to the display means 60. Further, the output information according to the present example embodiment is image information for causing the display means 60 to display an image indicating information about the alternative communication. In other words, by outputting the output information to the display means 60, the output unit 24 causes the display means 60 to display the image indicating the information about the alternative communication.

The output unit 24 may instruct the wireless communication means 40 to use an alternative communication. In this case, the output information may be instruction information indicating an instruction to the wireless communication means 40. When instruction input for giving an instruction to use one of alternative communications is performed, the output unit 24 may instruct the wireless communication means 40 to use the alternative communication as instructed.

Next, examples of the estimation condition are described.

For example, the estimation condition refers to the received signal level being equal to or greater than a first threshold value and the throughput being equal to or less than a second threshold value. The condition indicates reduced throughput despite a sufficient signal level. In such a case, it is highly likely that radio interference is occurring. The SINR may be used in the estimation condition in place of the throughput.

The estimation condition may refer to the received signal level being equal to or greater than the first threshold value and the PER being equal to or greater than a third threshold value. The BER may be used in the estimation condition in place of the PER.

For example, the estimation condition may be a condition based on a date and time and a location. For example, it is assumed that radio interference is known to occur due to passing of an interference source at a specific location at a specific time on a specific day of the week. In such a case, the estimation condition may refer to the specific time (time period) on the specific day of the week for the specific location.

When information of a location is used, the information output device 20 can recognize the position of the wireless communication means 40 by a global navigation satellite system (GNSS) or the like. Further, the wireless communication means 40 may recognize positional information of the wireless communication means 40 by a GNSS or the like, and the information output device 20 may receive the positional information of the wireless communication means 40 from the wireless communication means 40.

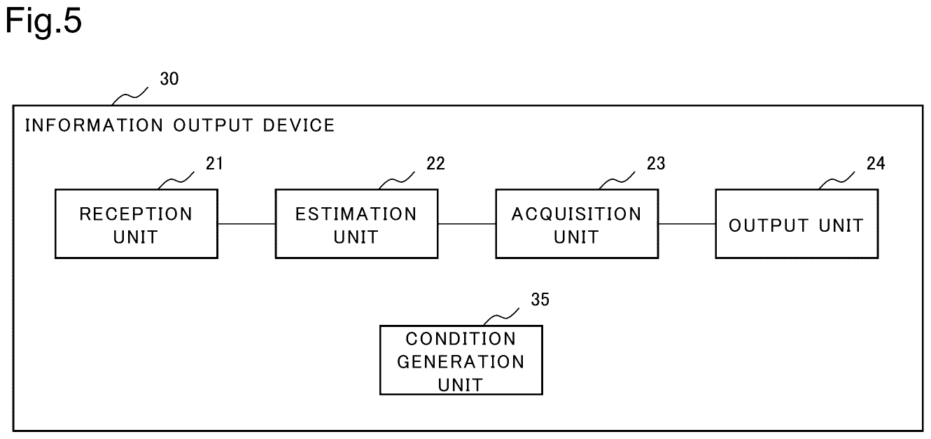

The estimation condition may be generated based on a history of past estimation results. For example, the estimation unit 22 stores information about a date and time and a location when and where radio interference is estimated to be occurring into the storage means 50. Then, based on a history of the information about a date and time and a location when and where radio interference is estimated to be occurring, the condition generation unit 35 generates a condition for a date and time and a location when and where radio interference is estimated to be occurring. The condition generation unit 35 may be included in the information output device or may be outside the information output device 20. For example, the condition generation unit 35 may generate the estimation condition by machine learning. FIG. 5 illustrates a configuration example of the information output device 30 including the condition generation unit 35.

The estimation condition may be a combination of a plurality of (two or more) individual estimation conditions described above. An individual estimation condition is hereinafter referred to as an individual condition. For example, the estimation condition may refer to satisfaction of one or more individual conditions or satisfaction of a predetermined or greater number of individual conditions.

Next, a method for acquiring alternative communication information is described.

The acquisition unit 23 acquires alternative communication information being communication information of an alternative communication from the storage means 50. Communication information for each wireless communication available to the wireless communication means 40 is stored in the storage means 50. Wireless communications excluding an in-use communication out of wireless communications a resource candidate of each is stored in the storage means 50 are referred to as alternative candidates. The alternative candidates are wireless communications excluding the in-use communication out of wireless communications available to the wireless communication means 40.

When one alternative candidate exists, the acquisition unit 23 may acquire, as alternative communication information, communication information of the alternative candidate. When a plurality of (two or more) alternative candidates exist, the acquisition unit 23 may acquire, as alternative communication information, communication information of all or part of the alternative candidates.

The acquisition unit 23 may determine a wireless communication the communication range of which is longer than the distance between the wireless communication means 40 and a communication counterpart to be an alternative communication. In this case, the acquisition unit 23 acquires, as alternative communication information, communication information of a wireless communication the communication range of which is longer than the distance between the wireless communication means 40 and the communication counterpart out of pieces of communication information of alternative candidates. The communication counterpart is a connection destination of wireless communication performed by the wireless communication means 40. For example, when wireless communication is performed through a base station, an access point, or the like, the communication counterpart is the base station, the access point, or the like. When wireless communication is performed between terminals without a base station, an access point, or the like in between, the communication counterpart is the terminal at the opposite end.

When the acquisition unit 23 compares the distance between the wireless communication means 40 and the communication counterpart with the communication range, communication information stored in the storage means 50 includes information about the communication range.

Thus, the acquisition unit 23 can acquire, as alternative communication information, communication information of a wireless communication the communication counterpart of which is within the communication range. Therefore, the acquisition unit 23 can determine the alternative communication information as communication information of a wireless communication with a higher possibility of communication out of alternative candidates. Then, user convenience can be further improved.

The acquisition unit 23 can calculate the distance between the wireless communication means 40 and a communication counterpart, based on positional information of the communication counterpart and positional information of the wireless communication means 40. More specifically, the acquisition unit 23 can calculate the distance between the wireless communication means 40 and a communication counterpart as follows.

When the position of the communication counterpart is fixed, the acquisition unit 23 may acquire the positional information of the communication counterpart from the storage means 50. In this case, it is assumed that the storage means 50 stores positional information of a communication counterpart in association with each wireless communication available to the wireless communication means 40. When positional information of a plurality of (two or more) communication counterparts is stored in the storage means 50 for one wireless communication, the acquisition unit 23 may perform a comparison with the communication range for a communication counterpart closest to the position of the wireless communication means 40.

When the wireless communication means 40 is equipped on a ship, an aircraft, or the like, positional information of a ship or the like belonging to the same group may be exchanged by a communication different from the in-use communication. When the communication counterpart is equipped on such a ship or the like, the acquisition unit 23 may use positional information recognizable by a communication different from the in-use communication as positional information of the communication counterpart.

For example, the acquisition unit 23 may determine a wireless communication using a frequency unused at the location of the wireless communication means 40 to be an alternative communication. In this case, the acquisition unit 23 acquires, as alternative communication information, communication information of the wireless communication using the unused frequency at the location of the wireless communication means 40 out of pieces of communication information of alternative candidates. In this case, the wireless communication means 40 may have a function of investigating an unused frequency, such as a spectrum analysis function. Then, the acquisition unit 23 may cause the wireless communication means 40 to investigate an unused frequency.

The acquisition unit 23 may cause the wireless communication means 40 to try communications using alternative candidates and determine an alternative candidate enabling communication by the wireless communication means 40 to be an alternative communication. In this case, the acquisition unit 23 acquires, as alternative communication information, communication information of a wireless communication enabling communication by the wireless communication means 40 out of pieces of communication information of alternative candidates. For example, the wireless communication means 40 can try a communication using an alternative candidate by a method such as transmitting trial data to a communication counterpart.

The acquisition unit 23 may determine a wireless communication the communication frequency of which is lower than a predetermined frequency out of alternative candidates to be an alternative communication. In this case, the acquisition unit 23 acquires, as alternative communication information, communication information of a wireless communication the communication frequency of which is lower than the predetermined frequency. The reception unit 21 may receive information about the communication frequency of an alternative candidate from the wireless communication means 40.

The acquisition unit 23 may acquire alternative communication information, based on a past history of information about an available frequency. For example, the storage means 50 further stores a past history of information about an available frequency. Then, the acquisition unit 23 may determine a wireless communication using a frequency that has been available in the past at the location of the wireless communication means 40 out of alternative candidates to be an alternative communication. The acquisition unit 23 acquires, as alternative communication information, communication information of the alternative communication. In this case, the communication information of the alternative communication is communication information of a wireless communication using the frequency that has been available in the past at the location of the wireless communication means 40 out of pieces of communication information of alternative candidates.

For example, the past history of information about an available frequency may be based on a result of spectrum analysis by the wireless communication means 40. The past history of information about an available frequency may be information of a wireless communication that has been available to the wireless communication means 40 in the past. In this case, the wireless communication means 40 can collect a plurality of correspondence relations between a spatial position, a date and time, and information about an available frequency by movement of the mobile unit 70 equipped with the wireless communication means 40.

The past history of information about an available frequency may be information about an available frequency, the information being acquired by a wireless communication means equipped on another mobile unit or an information acquisition device installed in a fixed manner. The information acquisition device in this case has a function of investigating an available frequency (such as the spectrum analysis function). In this case, available frequency information acquired by another wireless communication means, or the information acquisition device installed in a fixed manner may be collected by a management device (unillustrated). Then, the storage means 50 may store the information collected by the management device as the past history of information about an available frequency.

The acquisition unit 23 may estimate a currently available frequency, based on the past history of information about an available frequency. For example, the acquisition unit 23 estimates a frequency available at the current date and time and the current location of the wireless communication means 40, based on the history of information about an available frequency. The acquisition unit 23 acquires, as alternative communication information, communication information of an alternative communication. In this case, the alternative communication is a wireless communication using the frequency available at the current date and time and the current location of the wireless communication means 40 out of alternative candidates. The acquisition unit 23 may use machine learning for estimation of an available frequency. For example, the acquisition unit 23 may estimate an available frequency by using an estimation model estimating an available frequency. In this case, when date and time information and positional information are input, the estimation model outputs information about a frequency available at the date and time and the position. The information output device 20 may include a model generation unit (unillustrated) generating an estimation model.

A plurality of methods for acquiring alternative communication information have been described above. The acquisition unit 23 can acquire alternative communication information by one, or a plurality of (two or more) methods out of the methods described above. When alternative communication information is acquired by a plurality of (two or more) methods, for example, the acquisition unit 23 can acquire alternative communication information as follows. For example, the acquisition unit 23 may acquire, as alternative communication information, communication information of a wireless communication satisfying one or more acquisition conditions out of a plurality of (two or more) acquisition conditions. Further, for example, the acquisition unit 23 may acquire, as alternative communication information, communication information of a wireless communication satisfying a predetermined or greater number of acquisition conditions out of a plurality of (two or more) acquisition conditions. An acquisition condition is a condition for a wireless communication the communication information of which is acquired as alternative communication information in each method. Acquisition conditions are conditions in the methods described above, such as a condition based on a distance, a condition based on whether communication is possible, and a condition based on a communication frequency.

Next, specific examples of an image which the output unit 24 causes the display means 60 to display are described.

For example, the image may include alternative communication information. When the acquisition unit 23 acquires a plurality of (two or more) pieces of alternative communication information, the image may include a screen item for instruction input for giving an instruction to use one of the pieces of alternative communication.

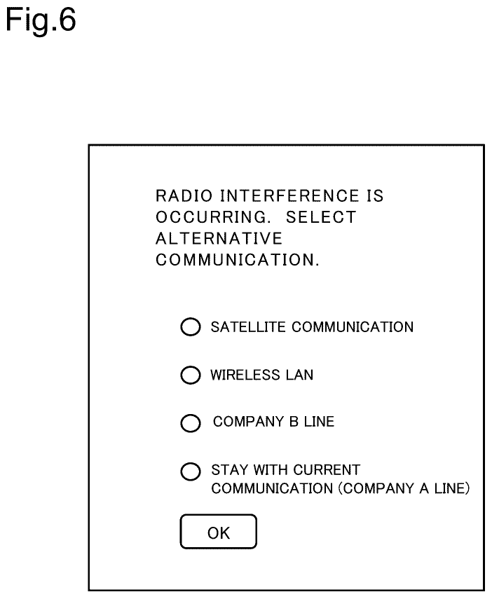

FIG. 6 is a diagram illustrating an example of an image which the output unit 24 causes the display means 60 to display. In the example in FIG. 6, the image includes a plurality of names of alternative communications. Further, in the example in FIG. 6, a radio button is a screen item for instruction input for giving an instruction to use one of the plurality of alternative communications.

When instruction input for giving an instruction to use one of the alternative communications is performed, the output unit 24 may instruct the wireless communication means 40 to use the alternative communication as instructed. In this case, the instruction input is input to the output unit 24 by a user operation being performed on the screen item.

When a plurality of (two or more) pieces of alternative communication information acquired by the acquisition unit 23 exist, the pieces of alternative communication information included in an image may be displayed in any order. For example, the display order may be a predetermined order of priority. Further, the display order may be an ascending order of communication frequency.

The display order may be an order of communication quality. In this case, the acquisition unit 23 causes the wireless communication means 40 to perform communication based on an alternative communication. Then, the reception unit 21 receives information about the communication quality of the communication based on the alternative communication. The output unit 24 rearranges the pieces of alternative communication information included in the image in a descending order of communication quality.

For example, the image may include a screen item indicating the wireless communication means 40 at the position of the wireless communication means 40 on a map. In this case, the image may include a screen item indicating a connection destination (a connection counterpart) at the position of the connection destination on a map. The connection destination in this case is a connection destination to which the wireless communication means 40 is connected by using an alternative communication. When the position of the connection destination is unknown or the position of the connection destination is not included on a map, the screen item indicating the connection destination may be displayed at any position on the image.

The image may include at least part of alternative communication information for each alternative communication. For example, the image may include the name, the operating frequency, and/or the like of an alternative communication. The image may include information about the communication frequency of each alternative communication. The image may include information about the communication quality of each alternative communication.

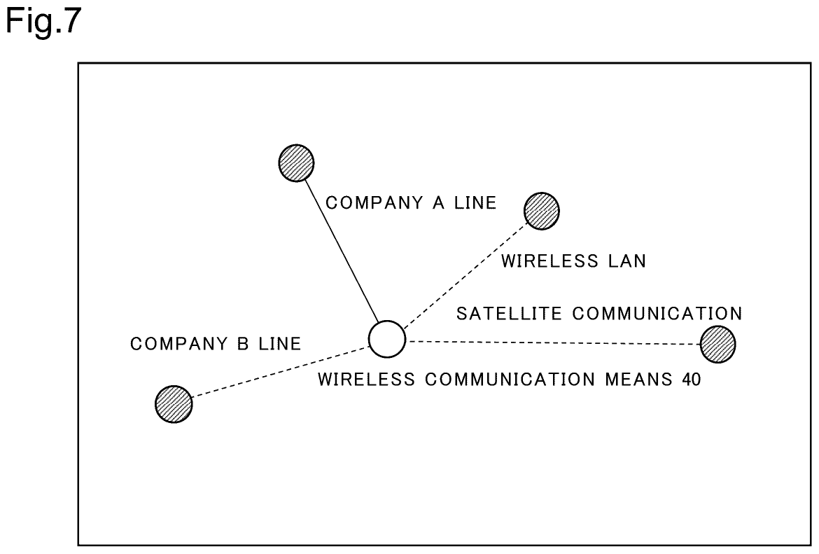

FIG. 7 illustrates an example of an image which the output unit 24 causes the display means 60 to display. In the example in FIG. 7, the image includes a screen item indicating the wireless communication means 40. Further, the image includes a screen item indicating a connection destination in each alternative communication. The screen items may be distinguished from each other by the color, the pattern, and/or the like. In the example in FIG. 7, an in-use communication is indicated by a solid line. An alternative communication is indicated by a broken line. A broken line may be a screen item for instruction input for giving an instruction to use an alternative communication. For example, when a broken line is selected by a user operation, instruction input for giving an instruction to use an alternative communication related to the broken line may be performed.

The output unit 24 may output output information to an output destination other than the display means 60. For example, the output information may be data including information about an alternative communication.

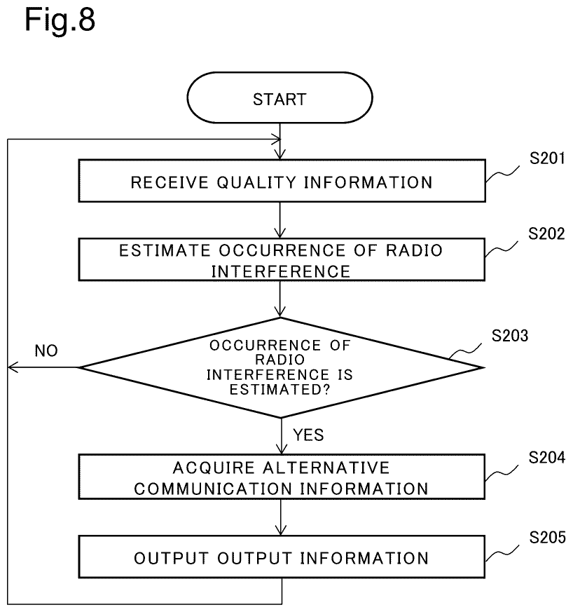

Next, an example of an operation flow of the information output device 20 according to the present example embodiment is described. FIG. 8 illustrates an example of the operation flow of the information output device 20 according to the present example embodiment.

The reception unit 21 receives quality information from the wireless communication means 40 (Step S201). According to the present example embodiment, quality information is transmitted from the wireless communication means 40 at every predetermined time.

The estimation unit 22 estimates occurrence of radio interference on an in-use communication, based on the quality information (Step S202). According to the present example embodiment, estimation is performed at every predetermined time.

When occurrence of radio interference on the in-use communication is estimated (YES in Step S203), the acquisition unit 23 acquires alternative communication information from the storage means 50 (Step S204). The output unit 24 outputs output information including the alternative communication information (Step S205). For example, when alternative communication information acquired by the acquisition unit 23 does not exist, the output unit 24 may output information indicating that radio interference is occurring but an alternative communication does not exist. Further, the output unit 24 may output the output information when, for example, receiving a request from a device being an output destination of the alternative communication information.

As described above, the information output device 20 according to the second example embodiment of the present invention includes the reception unit 21, the estimation unit 22, the acquisition unit 23, and the output unit 24. The reception unit 21 receives quality information from a wireless communication means. The wireless communication means performs wireless communication. The quality information is information about quality of an in-use communication. The in-use communication is a wireless communication used by the wireless communication means. The estimation unit 22 estimates occurrence of radio interference on the in-use communication, based on the quality information. The acquisition unit 23 acquires alternative communication information from the storage means when occurrence of radio interference on the in-use communication is estimated. The storage means stores communication information for each wireless communication available to the wireless communication means. Communication information is information about a wireless communication. An alternative communication is a wireless communication available to the wireless communication means in place of the in-use communication. Alternative communication information is communication information of an alternative communication. A wireless communication available to the wireless communication means in place of the in-use communication is a wireless communication using a wireless communication method different from that used by the in-use communication or a wireless communication provided by an operator different from that of the in-use communication. The output unit 24 outputs output information including the alternative communication information.

Thus, the information output device 20 outputs information including communication information of a wireless communication available to the wireless communication means in place of the in-use communication when occurrence of radio interference on the in-use communication is estimated. Since the information of a wireless communication available to the wireless communication means in place of the in-use communication is output from the information output device 20, a user can change the wireless communication used by the wireless communication means from the in-use communication to another wireless communication with reference to the output information. As a result, the possibility of communication being continued by avoiding radio interference increases. Further, the user can more easily take action against radio interference. Therefore, information for action against radio interference to be more easily taken can be output.

The acquisition unit 23 according to the present example embodiment may acquire, as alternative communication information, communication information of a wireless communication the communication range of which is longer than the distance between a communication counterpart being a connection destination of wireless communication performed by the wireless communication means 40 and the wireless communication means 40.

The acquisition unit 23 according to the present example embodiment may acquire, as alternative communication information, communication information of a wireless communication using a frequency unused at the location of the wireless communication means 40.

The acquisition unit 23 according to the present example embodiment may acquire, as alternative communication information, communication information of a wireless communication enabling communication by the wireless communication means 40.

The acquisition unit 23 according to the present example embodiment may acquire, as alternative communication information, communication information of a wireless communication the communication frequency of which is lower than a predetermined frequency.

The acquisition unit 23 according to the present example embodiment may acquire, as alternative communication information, communication information of a wireless communication using a frequency that has been available in the past at the location of the wireless communication means 40.

The acquisition unit 23 according to the present example embodiment may estimate a frequency available at the current date and time and the location of the wireless communication means 40, based on a past history of information about an available frequency. The acquisition unit 23 may acquire, as alternative communication information, communication information of a wireless communication using a frequency available at the current date and time and the current location of the wireless communication means 40.

From the above, the information output device 20 can present a user with a wireless communication with a high possibility of communication as an alternative communication.

According to the present example embodiment, when a plurality of pieces of acquired alternative communication information exist, output information includes the pieces of alternative communication information in one of orders out of an order of priority, an order of communication frequency, and an order of communication quality. Thus, user convenience can be improved.

The output unit 24 according to the present example embodiment outputs output information to the display means 60 for displaying an image. The output information is image information for causing the display means 60 to display an image. The image includes a screen item for instruction input for giving an instruction to use an alternative communication. Thus, a user can more easily perform switching to the alternative communication.

The image according to the present example embodiment further includes a screen item indicating the wireless communication means 40 at the position of the wireless communication means 40 on a map and also includes a screen item indicating a connection destination to which the wireless communication means 40 is connected by using an alternative communication at the position of the connection destination on the map. Thus, the user can recognize the position of the connection destination in the alternative communication and determine whether to switch to the alternative communication.

### [Hardware Configuration Example]

A configuration example of a hardware resource providing the information output device (10, 20, 30) according to each example embodiment of the present invention described above by using one information processing device (one computer) is described. The information output device may be provided by physically or functionally using at least two information processing devices. The information output device may be provided as a dedicated device. Only part of the functions of the information output device may be provided by using the information processing device.

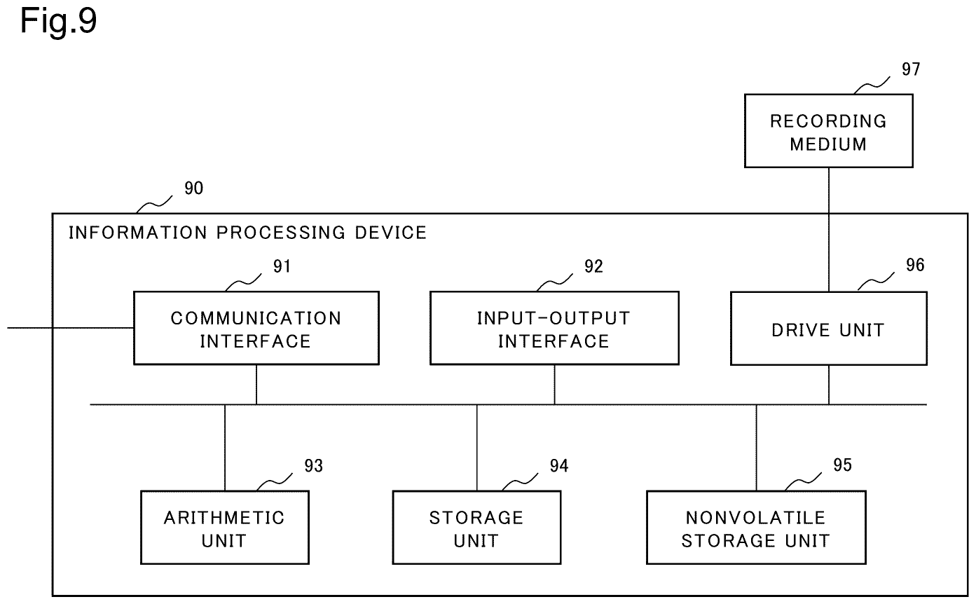

FIG. 9 is a diagram schematically illustrating a hardware configuration example of an information processing device that can provide the information output device according to each example embodiment of the present invention. The information processing device 90 includes a communication interface 91, an input-output interface 92, an arithmetic unit 93, a storage unit 94, a nonvolatile storage unit 95, and a drive unit 96.

For example, the reception unit 11 and the output unit 14 in FIG. 1 can be provided by the communication interface 91 and the arithmetic unit 93, and the estimation unit 12 and the acquisition unit 13 can be provided by the arithmetic unit 93.

The communication interface 91 is a communication means for the information output device according to each example embodiment to communicate with an external device in a wired or wireless manner. When the information output device is provided by using at least two information processing devices, the devices may be communicably connected to each other through the communication interface 91.

The input-output interface 92 is a human-machine interface with a keyboard being an example of an input device, a display as an output device, and the like.

The arithmetic unit 93 is provided by an arithmetic processing unit, such as a general-purpose central processing unit (CPU) or microprocessor, or a plurality of electric circuits. For example, the arithmetic unit 93 can read various programs stored in the nonvolatile storage unit 95 into the storage unit 94 and execute processing in accordance with the read programs.

The storage unit 94 is a memory unit, such as a random-access memory (RAM), referenceable from the arithmetic unit 93 and stores programs, various types of data, and the like. The storage unit 94 may be a volatile memory unit.

For example, the nonvolatile storage unit 95 is a nonvolatile storage unit, such as a read-only memory (ROM) or a flash memory, and can store various programs, various types of data, and the like.

For example, the drive unit 96 is a device processing reading and writing of data from and to a recording medium 97 to be described later. For example, the recording medium 97 is any recording medium, such as an optical disk, a magneto-optical disk, or a semiconductor flash memory, that can record data.

For example, each example embodiment of the present invention may be provided by configuring an information output device with the information processing device 90 illustrated in FIG. 9 and supplying a program that can provide the functions described in each of the aforementioned example embodiments to the information output device.

In this case, the example embodiment can be provided by executing the program supplied to the information output device by the arithmetic unit 93. Part of rather than all of the functions of the information output device may be configured with the information processing device 90.

Furthermore, the aforementioned program may be recorded on the recording medium 97, and the information output device may be configured in such a way that the aforementioned program is appropriately stored into the nonvolatile storage unit 95 in a shipping stage, an operation stage, or the like of the information output device. In this case, a method of installation into the information output device by using a suitable jig in a manufacture stage before shipping, the operation stage, or the like may be employed as a method for supplying the aforementioned program. The method for supplying the aforementioned program may employ a common procedure such as a method of externally downloading the program through a communication line such as the Internet.

The whole or part of the example embodiments disclosed above may also be described as, but not limited to, the following Supplementary Notes.

### (Supplementary Note 1)

An information output device comprising:
a reception means for receiving, for an in-use communication being a wireless communication used by a wireless communication means for performing wireless communication, quality information being information about quality of the in-use communication from the wireless communication means;
an estimation means for estimating occurrence of radio interference on the in-use communication, based on the quality information;
an acquisition means for acquiring alternative communication information from a storage means when occurrence of the radio interference on the in-use communication is estimated; and
an output means for outputting output information including the alternative communication information, wherein
the storage means stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

### (Supplementary Note 2)

The information output device according to Supplementary Note 1, wherein
the acquisition means acquires, as the alternative communication information, the communication information of a wireless communication a communication range of which is longer than a distance between a communication counterpart being a connection destination of wireless communication performed by the wireless communication means and the wireless communication means.

### (Supplementary Note 3)

The information output device according to Supplementary Note 1 or 2, wherein
the acquisition means acquires, as the alternative communication information, the communication information of a wireless communication using a frequency unused at a location of the wireless communication means.

### (Supplementary Note 4)

The information output device according to any one of Supplementary Notes 1 to 3, wherein
the acquisition means acquires, as the alternative communication information, the communication information of a wireless communication enabling communication by the wireless communication means.

### (Supplementary Note 5)

The information output device according to any one of Supplementary Notes 1 to 4, wherein
the acquisition means acquires, as the alternative communication information, the communication information of a wireless communication a communication frequency of which is lower than a predetermined frequency.

### (Supplementary Note 6)

The information output device according to any one of Supplementary Notes 1 to 5, wherein
the acquisition means acquires, as the alternative communication information, the communication information of a wireless communication using a frequency that has been available in a past at a location of the wireless communication means.

### (Supplementary Note 7)

The information output device according to any one of Supplementary Notes 1 to 6, wherein
the acquisition means
   estimates a frequency available at a current date and time and a location of the wireless communication means, based on a past history of information about an available frequency and
   acquires, as the alternative communication information, the communication information of a wireless communication using a frequency available at a current date and time and a current location of the wireless communication means.

### (Supplementary Note 8)

The information output device according to any one of Supplementary Notes 1 to 7, wherein,
when a plurality of pieces of the acquired alternative communication information exist, the output information includes pieces of the alternative communication information in one of orders out of an order of priority, an order of communication frequency, and an order of communication quality.

### (Supplementary Note 9)

The information output device according to any one of Supplementary Notes 1 to 8, wherein
the output means outputs the output information to a display means for displaying an image,
the output information is image information for causing the display means to display the image, and
the image includes a screen item for instruction input for giving an instruction to use the alternative communication.

### (Supplementary Note 10)

The information output device according to Supplementary Note 9, wherein
the image further includes a screen item indicating the wireless communication means at a position of the wireless communication means on a map and also includes a screen item indicating a connection destination to which the wireless communication means is connected by using the alternative communication at a position of a connection destination on a map.

### (Supplementary Note 11)

The information output device according to any one of Supplementary Notes 1 to 8, wherein
the output means outputs the output information to a display means for displaying an image,
the output information is image information for causing the display means to display the image, and
the image includes a screen item indicating the wireless communication means at a position of the wireless communication means on a map and also includes a screen item indicating a connection destination to which the wireless communication means is connected by using the alternative communication at a position of a connection destination on a map.

### (Supplementary Note 12)

An information output method comprising:
receiving, for an in-use communication being a wireless communication used by a wireless communication means for performing wireless communication, quality information being information about quality of the in-use communication from the wireless communication means;
estimating occurrence of radio interference on the in-use communication, based on the quality information;
acquiring alternative communication information from a storage means when occurrence of the radio interference on the in-use communication is estimated; and
outputting output information including the alternative communication information, wherein
the storage means stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

### (Supplementary Note 13)

The information output method according to Supplementary Note 12, wherein
the communication information of a wireless communication a communication range of which is longer than a distance between a communication counterpart being a connection destination of wireless communication performed by the wireless communication means and the wireless communication means is acquired as the alternative communication information.

### (Supplementary Note 14)

The information output method according to Supplementary Note 12 or 13, wherein
the communication information of a wireless communication using a frequency unused at a location of the wireless communication means is acquired as the alternative communication information.

### (Supplementary Note 15)

The information output method according to any one of Supplementary Notes 12 to 14, wherein
the communication information of a wireless communication enabling communication by the wireless communication means is acquired as the alternative communication information.

### (Supplementary Note 16)

The information output method according to any one of Supplementary Notes 12 to 15, wherein
the communication information of a wireless communication a communication frequency of which is lower than a predetermined frequency is acquired as the alternative communication information.

### (Supplementary Note 17)

The information output method according to any one of Supplementary Notes 12 to 16, wherein
the communication information of a wireless communication using a frequency that has been available in a past at a location of the wireless communication means is acquired as the alternative communication information.

### (Supplementary Note 18)

The information output method according to any one of Supplementary Notes 12 to 17, further comprising:
estimating a frequency available at a current date and time and a location of the wireless communication means, based on a past history of information about an available frequency, wherein
the communication information of a wireless communication using a frequency available at a current date and time and a current location of the wireless communication means is acquired as the alternative communication information.

### (Supplementary Note 19)

The information output method according to any one of Supplementary Notes 12 to 18, wherein,
when a plurality of pieces of the acquired alternative communication information exist, the output information includes pieces of the alternative communication information in one of orders out of an order of priority, an order of communication frequency, and an order of communication quality.

### (Supplementary Note 20)

The information output method according to any one of Supplementary Notes 12 to 19, wherein
the output information is output to a display means for displaying an image,
the output information is image information for causing the display means to display the image, and
the image includes a screen item for instruction input for giving an instruction to use the alternative communication.

### (Supplementary Note 21)

The information output method according to Supplementary Note 20, wherein
the image further includes a screen item indicating the wireless communication means at a position of the wireless communication means on a map and also includes a screen item indicating a connection destination to which the wireless communication means is connected by using the alternative communication at a position of a connection destination on a map.

### (Supplementary Note 22)

The information output method according to any one of Supplementary Notes 12 to 19, wherein
the output information is output to a display means for displaying an image,
the output information is image information for causing the display means to display the image, and
the image includes a screen item indicating the wireless communication means at a position of the wireless communication means on a map and also includes a screen item indicating a connection destination to which the wireless communication means is connected by using the alternative communication at a position of a connection destination on a map.

### (Supplementary Note 23)

A computer-readable recording medium on which an information output program is recorded, the program causing a computer to provide:
a reception function of receiving, for an in-use communication being a wireless communication used by a wireless communication means for performing wireless communication, quality information being information about quality of the in-use communication from the wireless communication means;
an estimation function of estimating occurrence of radio interference on the in-use communication, based on the quality information;
an acquisition function of acquiring alternative communication information from a storage means when occurrence of the radio interference on the in-use communication is estimated; and
an output function of outputting output information including the alternative communication information, wherein
the storage means stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

### (Supplementary Note 24)

The computer-readable recording medium on which the information output program according to Supplementary Note 23 is recorded, wherein
the acquisition function acquires, as the alternative communication information, the communication information of a wireless communication a communication range of which is longer than a distance between a communication counterpart being a connection destination of wireless communication performed by the wireless communication means and the wireless communication means.

### (Supplementary Note 25)

The computer-readable recording medium on which the information output program according to Supplementary Note 23 or 24 is recorded, wherein
the acquisition function acquires, as the alternative communication information, the communication information of a wireless communication using a frequency unused at a location of the wireless communication means.

### (Supplementary Note 26)

The computer-readable recording medium on which the information output program according to any one of Supplementary Notes 23 to 25 is recorded, wherein
the acquisition function acquires, as the alternative communication information, the communication information of a wireless communication enabling communication by the wireless communication means.

### (Supplementary Note 27)

The computer-readable recording medium on which the information output program according to any one of Supplementary Notes 23 to 26 is recorded, wherein
the acquisition function acquires, as the alternative communication information, the communication information of a wireless communication a communication frequency of which is lower than a predetermined frequency.

### (Supplementary Note 28)

The computer-readable recording medium on which the information output program according to any one of Supplementary Notes 23 to 27 is recorded, wherein
the acquisition function acquires, as the alternative communication information, the communication information of a wireless communication using a frequency that has been available in a past at a location of the wireless communication means.

### (Supplementary Note 29)

The computer-readable recording medium on which the information output program according to any one of Supplementary Notes 23 to 28 is recorded, wherein
the acquisition function
   estimates a frequency available at a current date and time and a location of the wireless communication means, based on a past history of information about an available frequency and
   acquires, as the alternative communication information, the communication information of a wireless communication using a frequency available at a current date and time and a current location of the wireless communication means.

### (Supplementary Note 30)

The computer-readable recording medium on which the information output program according to any one of Supplementary Notes 23 to 29 is recorded, wherein,
when a plurality of pieces of the acquired alternative communication information exist, the output information includes pieces of the alternative communication information in one of orders out of an order of priority, an order of communication frequency, and an order of communication quality.

### (Supplementary Note 31)

The computer-readable recording medium on which the information output program according to any one of Supplementary Notes 23 to 30 is recorded, wherein
the output function outputs the output information to a display means for displaying an image,
the output information is image information for causing the display means to display the image, and
the image includes a screen item for instruction input for giving an instruction to use the alternative communication.

### (Supplementary Note 32)

The computer-readable recording medium on which the information output program according to Supplementary Note 31 is recorded, wherein
the image further includes a screen item indicating the wireless communication means at a position of the wireless communication means on a map and also includes a screen item indicating a connection destination to which the wireless communication means is connected by using the alternative communication at a position of a connection destination on a map.

### (Supplementary Note 33)

The computer-readable recording medium on which the information output program according to any one of Supplementary Notes 23 to 30 is recorded, wherein
the output function outputs the output information to a display means for displaying an image,
the output information is image information for causing the display means to display the image, and
the image includes a screen item indicating the wireless communication means at a position of the wireless communication means on a map and also includes a screen item indicating a connection destination to which the wireless communication means is connected by using the alternative communication at a position of a connection destination on a map.

### (Supplementary Note 34)

An information output system comprising:
a reception means for receiving, for an in-use communication being a wireless communication used by a wireless communication means for performing wireless communication, quality information being information about quality of the in-use communication from the wireless communication means;
an estimation means for estimating occurrence of radio interference on the in-use communication, based on the quality information;
an acquisition means for acquiring alternative communication information from a storage means when occurrence of the radio interference on the in-use communication is estimated; and
an output means for outputting output information including the alternative communication information, wherein
the storage means stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 20, 30 Information output device
11, 21 Reception unit
12, 22 Estimation unit
13, 23 Acquisition unit
14, 24 Output unit
40 Wireless communication means
50 Storage means
60 Display means
70 Mobile unit
90 Information processing device
91 Communication interface
92 Input-output interface
93 Arithmetic unit
94 Storage unit
95 Nonvolatile storage unit
96 Drive unit
97 Recording medium

What is claimed is:

1. An information output device comprising one or more memories storing instructions and one or more processors configured to execute the instructions to:
receive, for an in-use communication being a wireless communication used by wireless communication means for performing wireless communication, quality information being information about quality of the in-use communication from the wireless communication means;
estimate occurrence of radio interference on the in-use communication, based on the quality information;
acquire alternative communication information from storage when occurrence of the radio interference on the in-use communication is estimated; and
output information including the alternative communication information, wherein
the storage stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

2. The information output device according to claim 1, wherein
the communication information of a wireless communication a communication range of which is longer than a distance between a communication counterpart being a connection destination of wireless communication performed by the wireless communication means and the wireless communication means is acquired as the alternative communication information.

3. The information output device according to claim 1, wherein
the communication information of a wireless communication using a frequency unused at a location of the wireless communication means is acquired as the alternative communication information.

4. The information output device according to claim 1, wherein
the communication information of a wireless communication enabling communication by the wireless communication means is acquired as the alternative communication information.

5. The information output device according to claim 1, wherein
the communication information of a wireless communication a communication frequency of which is lower than a predetermined frequency is acquired as the alternative communication information.

6. The information output device according to claim 1, wherein
the communication information of a wireless communication using a frequency that has been available in a past at a location of the wireless communication means is acquired as the alternative communication information.

7. The information output device according to claim 1, wherein
the processors are configured to execute the instructions to estimate a frequency available at a current date and time and a location of the wireless communication means, based on a past history of information about an available frequency and
the communication information of a wireless communication using a frequency available at a current date and time and a current location of the wireless communication means is acquired as the alternative communication information.

8. The information output device according to claim 1, wherein,
when a plurality of pieces of the acquired alternative communication information exist, the output information includes pieces of the alternative communication information in one of orders out of an order of priority, an order of communication frequency, and an order of communication quality.

9. The information output device according to claim 1, wherein
the output information is output to display means for displaying an image,
the output information is image information for causing the display means to display the image, and
the image includes a screen item for instruction input for giving an instruction to use the alternative communication.

10. The information output device according to claim 9, wherein
the image further includes a screen item indicating the wireless communication means at a position of the wireless communication means on a map and also includes a screen item indicating a connection destination to which the wireless communication means is connected by using the alternative communication at a position of a connection destination on a map.

11. The information output device according to claim 1, wherein
the output is output information to display means for displaying an image,
the output information is image information for causing the display means to display the image, and
the image includes a screen item indicating the wireless communication means at a position of the wireless communication means on a map and also includes a screen item indicating a connection destination to which the wireless communication means is connected by using the alternative communication at a position of a connection destination on a map.

12. An information output method comprising:
receiving, for an in-use communication being a wireless communication used by wireless communication means for performing wireless communication, quality information being information about quality of the in-use communication from the wireless communication means;
estimating occurrence of radio interference on the in-use communication, based on the quality information;
acquiring alternative communication information from storage means when occurrence of the radio interference on the in-use communication is estimated; and
outputting output information including the alternative communication information, wherein
the storage means stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

13. The information output method according to claim 12, wherein
the communication information of a wireless communication a communication range of which is longer than a distance between a communication counterpart being a connection destination of wireless communication performed by the wireless communication means and the wireless communication means is acquired as the alternative communication information.

14. The information output method according to claim 12, wherein
the communication information of a wireless communication using a frequency unused at a location of the wireless communication means is acquired as the alternative communication information.

15. The information output method according to claim 12, wherein
the communication information of a wireless communication enabling communication by the wireless communication means is acquired as the alternative communication information.

16. The information output method according to claim 12, wherein
the communication information of a wireless communication a communication frequency of which is lower than a predetermined frequency is acquired as the alternative communication information.

17. The information output method according to claim 12, wherein
the communication information of a wireless communication using a frequency that has been available in a past at a location of the wireless communication means is acquired as the alternative communication information.

18. The information output method according to claim 12, further comprising:
estimating a frequency available at a current date and time and a location of the wireless communication means, based on a past history of information about an available frequency, wherein
the communication information of a wireless communication using a frequency available at a current date and time and a current location of the wireless communication means is acquired as the alternative communication information.

19. The information output method according to claim 12, wherein,
when a plurality of pieces of the acquired alternative communication information exist, the output information includes pieces of the alternative communication information in one of orders out of an order of priority, an order of communication frequency, and an order of communication quality.

20-22. (canceled)

23. A non-transitory computer-readable recording medium on which an information output program is recorded, the program causing a computer to provide:
a reception function of receiving, for an in-use communication being a wireless communication used by wireless communication means for performing wireless communication, quality information being information about quality of the in-use communication from the wireless communication means;
an estimation function of estimating occurrence of radio interference on the in-use communication, based on the quality information;
an acquisition function of acquiring alternative communication information from storage means when occurrence of the radio interference on the in-use communication is estimated; and
an output function of outputting output information including the alternative communication information, wherein
the storage means stores communication information being information about a wireless communication for each wireless communication available to the wireless communication means,
the alternative communication information is the communication information of an alternative communication being a wireless communication available to the wireless communication means in place of the in-use communication, and
the alternative communication is a wireless communication using a wireless communication method different from that used by the in-use communication or a wireless communication provided by an operator different from that of the in-use communication.

24-34. (canceled)
